(19) United States
(12) Patent Application Publication
(10) Pub. No.: US 2001/0024908 A1
(43) Pub. Date: Sep. 27, 2001

(54) Dustproof cover for a connector and prefitting dustproofing structure for a connector

(75) Inventors: Mitsuharu Nakamura, Shizuoka (JP); Takao Murakami, Shizuoka (JP)

Correspondence Address: MORGAN, LEWIS & BOCKIUS, 1800 M STREET NW, WASHINGTON, DC, 20036-5869, US

(73) Assignee: Yazaki Corporation

(21) Appl. No.: 09/811,506

(22) Filed: Mar. 20, 2001

(30) Foreign Application Priority Data
Mar. 21, 2000 (JP) P. 2000-78015

(51) Int. Cl. H01R 13/44

(52) U.S. Cl. 439/676

(57) ABSTRACT

In a cap-shaped dustproof cover for a connector which is fitted over an outer periphery of a connector from a front side of the connector in such a manner as to cover a front-end fitting surface of the connector, a packing protecting portion for covering packing exposed around an outer peripheral portion of a rear end of the connector is provided by extending an end of an opening of a peripheral wall of the cover. An inner peripheral surface of the packing protecting portion is formed in such a manner as to be brought into close contact with the packing.

### BACKGROUND OF THE INVENTION

1. Field of the Invention

The present invention relates to a dustproof cover for a connector and a prefitting dustproofing structure for a connector whereby the connector is protected by a dustproof cover before the connector is fitted to a mating connector.

The present application is based on Japanese Patent Application No. 2000-78015, which is incorporated herein by reference.

2. Description of the Related Art

In a waterproof connector for an automobile, one connector is provided with rubber-made packing for sealing a fitted portion when the connector is fitted to a mating connector, and this packing is generally protected by a hood portion formed integrally with a connector housing.

FIG. 3 shows an example of a connector having conventional packing.

A connector housing 1 is provided with a projection 2 for fitting in a recess of a mating connector, and annular packing 3 is fitted over an outer periphery of the projection 2. The connector housing 1 is provided with a hood portion 4 in such a manner as to surround the projection 2, and the packing 3 around the outer periphery of the projection 2 is protected by the hood portion 4.

Meanwhile, in the case of a connector for use in such as an air bag system of an automobile, it is mandatory to keep the fitting surface of the connector protected by a dustproof cover until the connector is fitted to a mating connector, so as to ensure safety and reliability.

However, with the conventional waterproof connector shown in FIG. 3, since the packing 3 is protected by the hood portion 4, there has been a problem in that the connector becomes large in size.

In addition, the conventional dustproof cover used for such as the connector for the air bag system is designed to merely protect the fitting surface of the connector.

### SUMMARY OF THE INVENTION

In view of the above-described circumstances, an object of the invention is to provide a dustproof cover having the function of protecting packing and a prefitting dustproofing structure whereby the connector is provided with dustproof protection by using the dustproof cover.

In accordance with the present invention, a cap-shaped dustproof cover for a connector which is fitted over an outer periphery of a connector from a front side of the connector n such a manner as to cover a front-end fitting surface of the connector is characterized in that a packing protecting portion for covering packing exposed around an outer peripheral portion of a rear end of the connector is provided by extending an end of an opening of a peripheral wall of the cover.

The connector in this case has packing in a state in which the packing is exposed around the outer peripheral portion of its rear end, and the packing is protected by the packing protecting portion provided by extending the end of the opening of the peripheral wall of the dustproof cover. Therefore, it is unnecessary to provide a hood portion on the connector side, the packing can be protected reliably, and since the hood portion is eliminated, the connector can be made compact. In addition, since it is sufficient to merely extend the end of the opening of the dustproof cover the fitting of which has been mandatory in a special case, the dustproof cover for a connector can be realized easily.

In addition, when the connector is fitted to a mating connector, the dustproof cover is removed, and the connector is fitted to the mating connector in the usual manner. Then, as the dustproof cover is removed, the packing which was protected by the packing protecting portion is exposed, and seals the gap with the mating connector.

In accordance with the second aspect of the present invention, the above dustproof cover for a connector is further characterized in that an inner peripheral surface of the packing protecting portion is formed in such a manner as to be brought into close contact with the packing.

Since this dustproof cover seals the gap by coming into close contact with the packing when the dustproof cover is fitted over the connector, it is possible to reliably prevent the entry of water and fine dust into the fitting surface of the connector. Further, since the dustproof cover is brought into close contact with the packing, the free play is prevented.

In accordance with the third aspect of the present invention, a dustproof covers for a connector described above is further characterized in that an engaging projection for engaging with a lock arm of the connector is provided on an inner peripheral surface of the peripheral wall of the cover.

When the dustproof cover is fitted over the connector, the lock arm is adapted to engage with the engaging projection, so that the dustproof cover is difficult to come off easily.

In accordance with the fourth aspect of the present invention, a prefitting dustproofing structure for a connector whereby the connector is provided with dustproof protection before the connector is fitted to a mating connector is characterized in that a dustproof cover described above is fitted over the outer periphery of the connector from its front side with packing exposed around the outer peripheral portion of the rear end of the connector, and that the packing is protected by the packing protecting portion of the dustproof cover.

According to this structure, since the dustproof cover the fitting of which is mandatory in a special case protects the packing as well, the hood portion which is conventionally provided for the protection of the packing can be eliminated, so that the connector can be made compact. In addition, since the packing exposed around the outer periphery of the connector is covered by the packing protecting portion, the sealing performance for the interior of the dustproof cover can be maintained. Hence, it is possible to protect the connector from the entry of water and fine dust into it, thereby improving the protecting function.

Additionally, in a accordance with the fifth aspect of the present invention, the prefitting dustproofing structure for a connector comprises a connector provided with a packing exposed around an outer peripheral portion of a rear end of said connector, and a dustproof cover having a packing protecting portion provided by extending an end of an opening of a peripheral wall thereof, wherein said dustproof cover is fitted to the outer periphery of said connector so as to cover a front-end fitting surface of a connector from a front side of said connection, and said packing protecting portion covers said packing.

### BRIEF DESCRIPTION OF THE DRAWING

FIGS. 1A and 1B show a dustproof cover in accordance with an embodiment of the invention, in which FIG. 1A is a cross-sectional view illustrating a state in which the dustproof cover is fitted over a connector, and FIG. 1B is a perspective view illustrating the dustproof cover which is cut in half;

FIG. 2 is a perspective view illustrating the external appearance of a subject connector to be protected by the dustproof cover in accordance with the embodiment of the invention; and

FIG. 3 is a perspective view illustrating the external appearance of a conventional waterproof connector.

### DETAIL DESCRIPTION OF THE PREFERRED EMBODIMENTS

Hereafter, a description will be given of an embodiment of the invention with reference to the drawings.

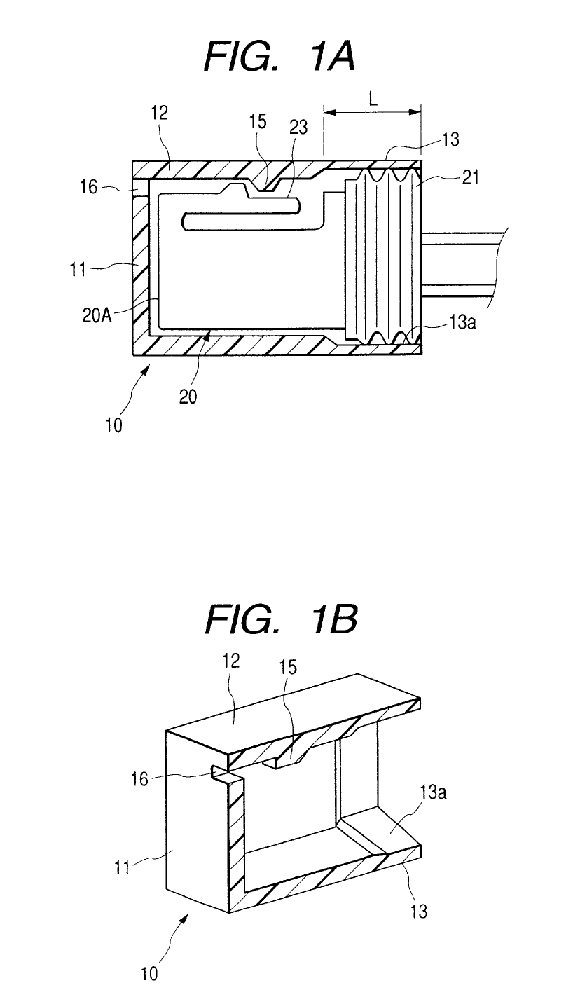

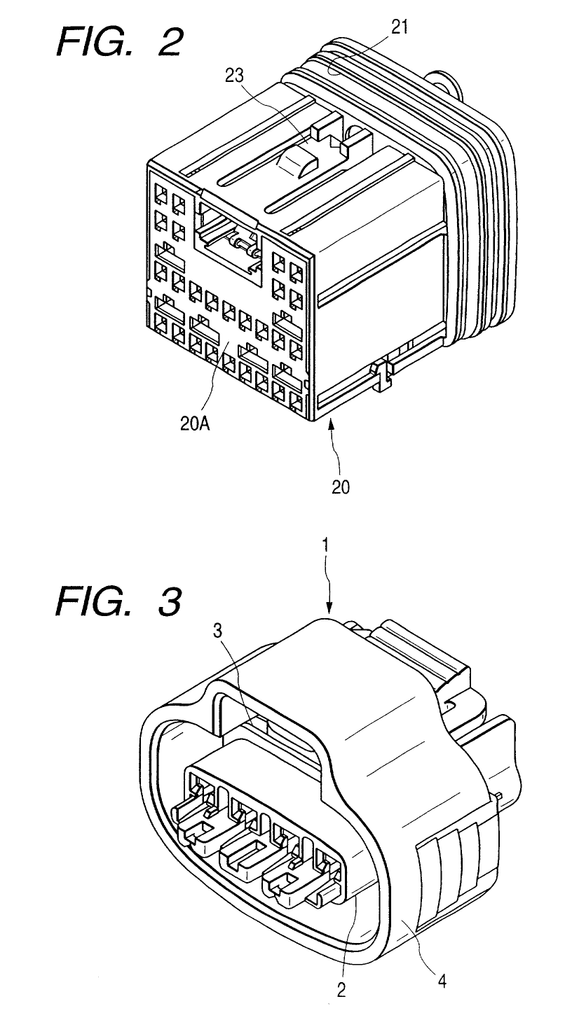

FIG. 1A is a cross-sectional view illustrating a state in which a dustproof cover in accordance with the embodiment is fitted over a connector, and FIG. 1B is a perspective view illustrating only the dustproof cover which is cut in half. In addition, FIG. 2 is aperspective view illustrating the external appearance of the subject connector.

As shown in FIG. 2, a subject connector 20 to be protected herein has at its front end a fitting surface 20A with respect to a mating connector, and is provided with packing 21 exposed around an outer peripheral portion of its outer end. The packing 21 is formed of an elastic material such as rubber, a thermoplastic elastomer, or the like.

This packing 21 is used for sealing a gap between the connectors by being brought into close contact with an inner periphery of a hood portion of the mating connector when the connector is fitted to the mating connector. A lock arm 23 for interlocking with the mating connector when the connector is fitted to the mating connector is provided at a position forward. of the packing 21.

Meanwhile, as shown in FIG. 1B, a dustproof cover 10 is formed of a resin in the shape of a square cap conforming with the outer shape of the connector 20, and has an end wall 11 for covering a front-end fitting surface 20A of the connector 20 as well as a peripheral wall 12 for covering the outer periphery of the connector 20. As shown in FIG. 1A, this dustproof cover 10 is fitted over the outer periphery of the connector 20 from the front side of the connector 20, and a packing protecting portion 13 for covering the packing 21 exposed around the outer peripheral portion of the rear end of the connector 20 is formed at an end of the opening of the peripheral wall 12 by extending the end of the opening a dimension L allowing the packing 21 to be covered. In this case, an inner peripheral surface 13a of the packing protecting portion 13 is formed with such an inside diameter that the inner peripheral surface 13a is lightly or strongly kept in contact with the packing 21.

In addition, an engaging projection 15 for engaging with the lock arm 23 of the connector 20 is provided on an inner peripheral surface of the peripheral wall 12 of the dustproof cover 10. In this case, since the dustproof cover 10 itself is formed in a bag shape, an operating hole 16 for forming the engaging projection 15 is formed in the end wall 11. This operating hole 16 is a small hole, and is located at a position where it does not directly confront the front-end fitting surface 20A of the connector 20.

Next, a description will be given of the structure and its operation in a case where the connector 20 is protected by the dustproof cover 10.

Since it is mandatory for this connector 20 to be provided with dustproof protection against the fitting surface 20A before the connector 20 is fitted to the mating connector, the dustproof cover 10 is fitted over the outer periphery of the connector 20 from the front side, as shown in FIG. 1A. Then, as the dustproof cover 10 is fitted until its front wall 11 abuts against the front end face of the connector 20, the lock arm 23 is engaged withtheengagingprojection15, thereby retaining the dustproof cover 10 so that it will not come off.

In that state, the dustproof cover 10 protects the fitting surface 20A of the connector 20 by its own end wall 11, and protects the packing 21 exposed around the outer peripheral portion of the rear end of the connector 20 by the packing protecting portion 13 provided at the end of its opening.

In addition, at this time, since the dustproof cover 10 is brought into close contact with the packing 21 and seals the gap, it is possible to reliably prevent the entry of water and fine dust into the connector 20, thereby improving the reliability of protection. Moreover, since the dustproof cover 10 is brought into close contact with the packing 21 made of an elastic material, the free play is prevented.

When the connector 20 provided with dustproof protection is fitted to the mating connector, the engagement between the lock arm 23 and the engaging projection 15 is canceled by deflecting the lock arm 23 by deforming the dustproof cover 10 or inserting a stick-like jig through the operating hole 16, the dustproof cover 10 is then removed, and the connector 20 is fitted to the mating connector in the usual manner. Consequently, the packing 21 which was protected by the packing protecting portion 13 of the dustproof cover 10 is exposed, and seals the fitting gap with the mating connector.

Thus, in the case where the above-described dustproof cover 10 is fitted over the connector 20, the packing 21 of the connector 20 can be also protected at the same time, so that it becomes unnecessary to provide the hood portion for protecting the packing 21 on the connector 20 side in the conventional manner. Accordingly, since the hood portion is eliminated, it is possible to make the connector compact, improve the space efficiency, and reduce the cost through the reduction of the material cost. In addition, since the function of protecting the packing 21 can be added by merely extending the end of the opening of the dustproof cover 10 the fitting of which has been mandatory in a special case, the prefitting dustproofing structure for a connector can be realized easily.

As described above, in accordance with the present invention, since the packing of the connector can be protected by the packing protecting portion provided by extending the end of the opening of the peripheral wall of the dustproof cover, it becomes unnecessary to provide the hood portion for protecting the packing on the connector side in the conventional manner. For this reason, since the hood portion is eliminated, it is possible to make the connector compact, improve the space efficiency, and reduce the cost through the reduction of the material cost. In addition, since it is sufficient to merely extend the end of the opening of the dustproof cover, the dustproof cover for a connector can be realized very easily.

Further in accordance with the present invent-on, since the dustproof cover is capable of sealing the gap by coming into close contact with the packing when the dustproof cover is fitted over the connector, it is possible to reliably prevent the entry of laser and fine dust into the fitting surface of the connector. In addition, since the dustproof cover is brought into close contact with the packing, an advantage can be obtained in that the free play is prevented.

Furthermore, in accordance with the present invention, when the dustproof cover is fitted over the connector, the lock arm is adapted to engage with the engaging projection, so that the dustproof cover is made difficult to come off easily, and handling efficiency improves.

Additionally, in accordance with the present invention, the dustproof cover also protects the packing of the connector, so as to obtain the above-described advantages.

What is claimed is:

1. A dustproof cover for a connector comprising:
a cap-shape cover; and
a packing protecting portion provided by extending an end of an opening of a peripheral wall of said cover;
wherein said cover is fitted to a connector so as to cover a front-end fitting surface of said connector from a front side of said connector and wherein said packing protecting portion covers a packing exposed around an outer peripheral portion of said connector.

2. A dustproof cover for a connector according to claim 1, wherein an inner peripheral surface of said packing protecting portion is formed in such a manner as to be brought into close contact with said packing.

3. A dustproof cover for a connector according to claim 1, further comprising:
an engaging projection provided on an inner surface of said peripheral wall of said cover;
wherein, said engaging projection is engaged with a lock arm provided on the outer periphery of said connector.

4. A prefitting dustproofing structure for a connector whereby said connector is provided with dustproof protection before said connector is fitted to a mating connector,
wherein a dustproof cover according to claim 1 is fitted to the outer periphery of said connector from its front side of said connector, and said packing is protected by said packing protecting portion of said dustproof cover.

5. A prefitting dustproofing structure for a connector comprising:
a connector provided with a packing exposed around an outer peripheral portion of a rear end of said connector; and
a dustproof cover having a packing protecting portion provided by extending an end of an opening of a peripheral wall thereof;
wherein said dustproof cover is fitted to the outer periphery of said connector so as to cover a front-end fitting surface of a connector from a front side of said connection, and said packing protecting portion covers said packing.

6. A prefitting dustproofing structure for a connector according to claim 5, wherein an inner peripheral surface of said packing protecting portion is formed in such a manner as to be brought into close contact with said packing.

7. A prefitting dustproofing structure for a connector according to claim 5,
wherein said dustproof cover comprises an engaging projection provided on an inner surface of said peripheral wall of said cover and said connector comprises a lock arm on the outer periphery thereof, and
wherein, said engaging projection is engaged with said lock arm when said dustproof cover is fitted to said connector.
